(19) United States
(12) Patent Application Publication
(10) Pub. No.: US 2017/0147791 A1
(43) Pub. Date: May 25, 2017

(54) SYSTEM AND METHOD FOR FACILITATING MEDICAL ADMISSIONS

(71) Applicant: Bradley M. Dalton, Las Vegas, NV (US)

(72) Inventor: Bradley M. Dalton, Las Vegas, NV (US)

(21) Appl. No.: 14/950,820

(22) Filed: Nov. 24, 2015

(51) Int. Cl. G06F 19/00

(52) U.S. Cl. CPC G06F 19/363; G06F 19/324

(57) ABSTRACT

A method for facilitating medical admissions includes ascertaining an understood language, accessing a database on an electronic device configured to communicate with a patient, selecting a translation of a question, and communicating the translation to the patient. The patient provides a response to the question to a medical professional without a translator. A system for facilitating medical admissions includes a database of prerecorded question translations by medical professionals and response cues. Potential responses to a question are limited to predetermined choices. Trust ratings are associated with the translations. Response cues provide answers to the questions to be communicated to a medical professional without a translator. A system for facilitating medical admissions includes reference information and a database containing closed-ended questions and translations. The reference information includes a translating medical professional's expertise and fluent language. Each translation is provided by a medical professional and reviewed by other medical professionals.

### BACKGROUND

The current field of medical translation is fragmented. Unlike court and legal translators, medical translators are not required to complete an exam or enroll in a paraprofessional association to provide medical translations. A medical professional wanting to complete the admissions or intake process with a patient might rely on a patient's family member or a member of the medical staff to provide translations. However, such action can be a danger for patients since the “translator” may lack the medical expertise to effectively translate and/or may not be a native speaker. These deficient translation options can put a patient's health at risk. Additionally, the use of an intermediary may violate the patient's privacy and, in some cases, result in less truthful answers. For example, a patient may be less candid when their responses are being relayed through another person, especially when discussing a sensitive issue.

Written intake questionnaires in a variety of languages are known for use in attempting to address the described problems. Even so, in many parts of the world, the number of migrants presenting themselves for medical attention has spiked. Recently, in Europe, “boat people” and/or refugees could not be assumed to be literate in their native language, making the idea of having patients read and respond to written intake questionnaires impossible. Moreover, migrant populations often have medical needs that do not reflect that of the general local patient population and may be difficult to predict in prepared forms. In fact, migrant patients may raise epidemiological concerns for the local population.

A medical aid worker working in a remote village or in a refugee camp in a more remote part of the globe may face additional problems as there may be multiple languages spoken where she is providing care. For example, the medical staff and patient may both speak a different language than the medical aid worker. Often medical aid workers in such circumstances have no reliable computer access or access to an Internet connection.

Known translation systems require sitting the patient directly in front of an electronic terminal to provide responses to the terminal, which excludes the medical professional from the initial care process. Known translation systems use either remote, live human translation transmitted to a patient in real time over a data connection, or electronic voice and/or text recognition systems to provide patients with non-human translations. Such systems risk patient safety by sacrificing accuracy and requiring additional time to achieve a translation. Additionally, such systems are limited to areas with reliable computer and internet access. Known translation systems require patients to read medical information and respond, but in many parts of the world it cannot be assumed that a patient is literate in their native language. This is especially true of medical professionals dealing with migrant populations. Known translation systems limit medical professionals to standard intake questions. In some cases, these standard intake questions are directed to a local patient population and fail to account for the unique circumstances presented by migrant populations. Known admissions systems may rely on electronically stored records to discover a patient's medical history, but such records may not exist for migrant patients.

### BRIEF DESCRIPTION OF THE DRAWINGS

Some embodiments are described below with reference to the following accompanying drawings.

FIG. 1 shows a flow diagram of a method for facilitating medical admissions.

FIG. 2 shows a flow diagram of a method for establishing translations in a database to facilitate medical admissions.

FIG. 3 shows a block diagram of a system for facilitating medical admissions between a medical professional and a patient with a communication barrier.

FIG. 4 shows a block diagram of an electronic device with a local memory configured to store at least a portion of an electronic database.

FIG. 5 shows response devices for the system shown in FIG. 3.

FIG. 6 shows an example of a user interface on an electronic device for a medical professional to access a database.

FIG. 7 shows an example of a user interface on an electronic device for reviewing medical professionals to verify the accuracy of translations.

FIG. 8 shows an example of a user interface on an electronic device for providing translations of closed-ended questions.

### DETAILED DESCRIPTION

The present disclosure relates generally to a system and method for facilitating medical admissions between medical professionals and patients. The medical professionals and patients might not speak a common language and the patients might be unable to read or write. The system and method may include a database of audio or video recordings, or both. Responses may be provided to the medical professional without the need of a translator.

A method for facilitating medical admissions includes a first medical professional ascertaining an understood language of a patient. A communication barrier may exist between the first medical professional and the patient. The first medical professional accesses an electronic database on an electronic device that is configured to communicate with the patient. The electronic database comprises a plurality of closed-ended questions in the first medical professional's understood language and corresponding prerecorded translations provided by other medical professionals. The prerecorded translations are audio or video translations, or both. The method includes the first medical professional selecting a first translation of a first question from among the prerecorded translations in the electronic database through the electronic device. The first translation corresponds to the understood language of the patient. The method includes communicating the first translation of the first question to the patient through the electronic device and eliciting a response to the first question from the patient. The potential responses are limited to a finite number of predetermined choices known to the first medical professional. The response is provided to the first medical professional without a translator.

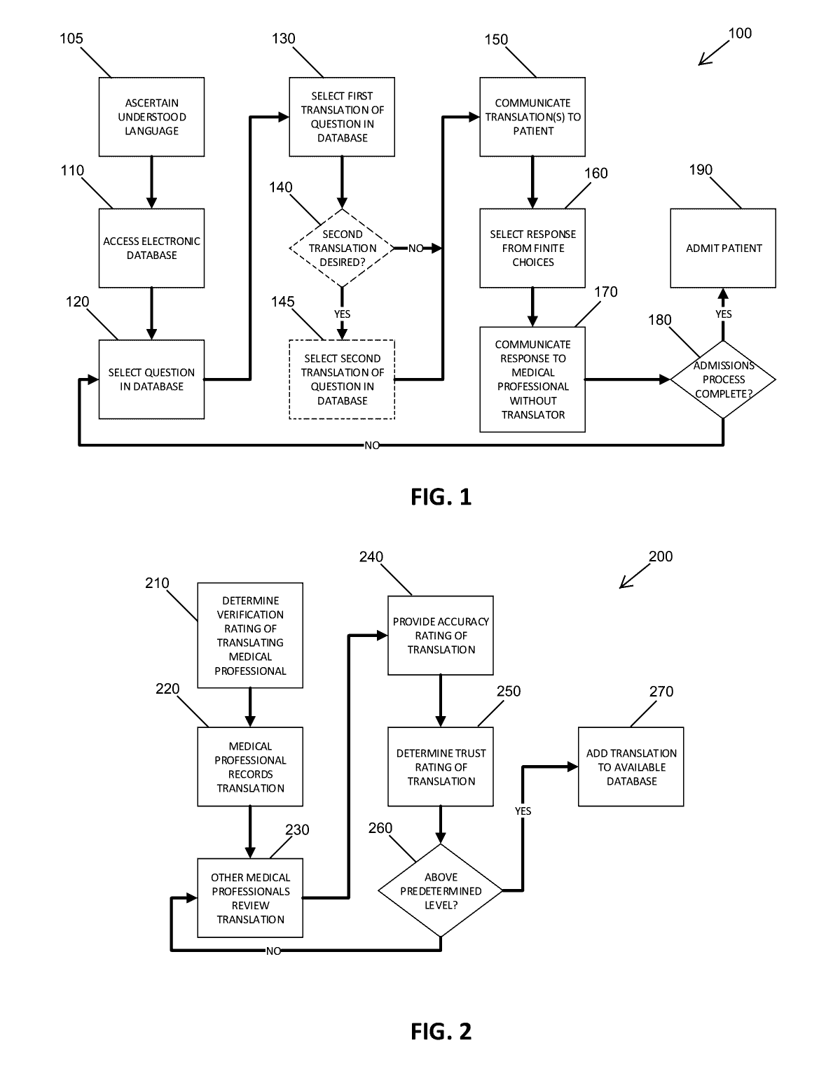

As an example of the above described method, FIG. 1 is a flow diagram of a method 100 for facilitating medical admissions. Step 105 includes a first medical professional ascertaining an understood language of a patient. A communication barrier exists between the first medical professional and the patient. The patient may identify their native language by identifying the region where he/she was raised. By way of example, the patient may identify the region using a map and the understood language may be ascertained using a corresponding latitude and longitude. The patient may identify the region by using an identification card, a menu on an electronic device, or the like. Based upon this information, the first medical professional may select a translation language that will most exactly replicate the patient's native language, tribal language, or dialect.

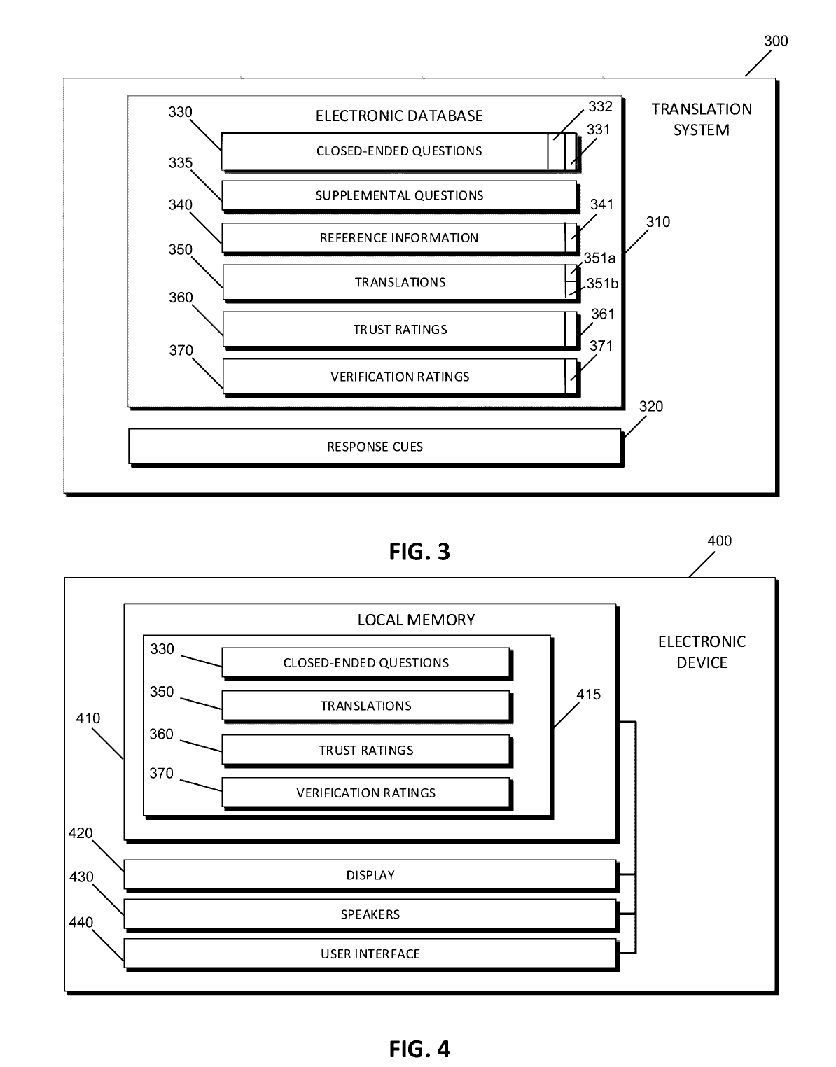

Step 110 includes the first medical professional accessing an electronic database, such as electronic database 310 of system 300 (shown in FIG. 3). Electronic database 310 may be accessed through an electronic device, such as electronic device 400 (shown in FIG. 4), including a personal computer, smartphone, or a tablet computer. The electronic device may be configured to communicate with the patient as described below with regard to electronic device 400. The electronic database may include data as described below with regard to electronic database 310. Even though method 100 is described below with reference to system 300 and electronic device 400, it is conceivable that method 100 may be carried out using other systems and/or electronic devices.

Electronic database 310 includes a plurality of closed-ended questions 330 in the first medical professional's understood language and corresponding prerecorded translations 350. Prerecorded translations 350 may be audio or video translations, or both. Translations 350 may be provided by medical professionals other than the first medical professional. The first medical professional selects desired question 331 in step 120.

The first medical professional selects translation 351a of desired question 331 from electronic database 310 in step 130. Translation 351a corresponds to the patient's understood language. Depending on the first medical professional's needs, the first medical professional may select any question or question set from electronic database 310. For example, an urgent need may prompt a first medical professional to select an abridged question set to more quickly determine the patient's condition. The first medical professional may create their own question sets before beginning the admissions process. The question sets may be targeted towards a particular demographic. For example, a question set for “West African Male” may include questions concerning Ebola Virus. A question set for “Migrant Children” may include childhood vaccination questions. The first medical professional may have complete autonomy in selecting which questions to use in the admissions process. Electronic database 310 may provide the first medical professional with a copy of questions 330 in the first medical professional's fluent language. For example, the first medical professional may view question 331 in English, but corresponding translation 351a may be provided to the patient in Hindi.

The first medical professional may determine second translation 351b of question 331 would be desirable in decision step 140. If second translation 351b of question 331 is desired, the first medical professional selects second translation 351b of question 331 from electronic database 310 in step 145. Second translation 351b is different from first translation 351a and is provided by a different medical professional than the first medical professional. The use of multiple translations of the same question, recorded by different translating medical professionals, may reduce the risk of miscomprehension by the patient. Depending on the complexity of a question, further alternative translations could be available. Steps 140 and 145 have been shown in FIG. 1 with dashed lines to indicate that steps 140 and 145 may be omitted in certain circumstances.

In step 150, electronic device 400 is used to communicate translation(s) 351a,b of first question 331 to the patient. A response to first question 331 is elicited in steps 160 and 170. The elicited response may be to both translations 351a,b of question 331. The potential responses to first question 331 are limited to a finite number of predetermined choices that are already known to the first medical professional. The potential responses may be included in the translation of each question. The potential responses may be the same for every question and the potential responses may only be communicated once.

The patient selects a response from the finite choices in step 160 and communicates the response and its corresponding answer to question 331 to the first medical professional without a translator in step 170. For example, the patient may hold up a response device, as discussed below. The absence of a real-time human translator preserves the patient's privacy and prevents undue delay in relaying the responses to the first medical professional. The response may be provided directly to the first medical professional from the patient.

In decision step 180, the first medical professional determines whether the admission process is complete. If the process is complete, then the patient is admitted in step 190. Otherwise, steps 120 through 180 are repeated until all of the desired admissions questions have been completed. For example, the process may be completed with additional questions 332.

The first medical professional may be provided with a series of questions 330 in the form of numbered audio or video recordings, or both, and a corresponding paper or electronic form for the first medical professional to complete. A question or question number, or both, on the form may correspond to a question in the electronic database 310. Accordingly, subsequent medical professionals may review a question and identify its corresponding answer on the form. As patients might not be literate in their own native language or dialect, the patient is not expected to read any questions.

The first medical professional may listen to the recorded translations with the patient and wait for a physical action or visual response cue from the patient. The first medical professional may then mark the answer corresponding to the response on the form. However, the first medical professional might not enter the responses into system 300. Instead, the first medical professional may forward the information within the organization, such as with the patient's paper or electronic medical chart. Alternatively, responses might be entered into system 300 with each interaction assigned its own identifier, but no patient names retained by system 300. Thus, without risking privacy concerns, the interactions may be used as data to track symptoms and diseases of a population evaluated with system 300, such as from a geographic region.

The potential responses to the plurality of closed-ended questions 330 may be limited to the same predetermined choices known to the first medical professional. One of the potential responses may be an indication that the patient chooses not to answer. The elicited response may be a nonverbal response.

Electronic device 400 may be a portable device having local memory 410. A portion of electronic database 310 may be stored in a database 415 on local memory 410 of the portable device. Accordingly, the first medical professional may access translations 350 in electronic database 415 from local memory 410 of the portable device.

Predetermined closed-ended questions 330 may include intake questions, triage questions, and epidemiology questions. Some translations 350 may be video translations of a question in a hearing-impaired language, such as American Sign Language. Other translations 350 may be audio translations. Still other translations may be a video of a person speaking or signing along with the accompanying audio.

Closed-ended questions 330 may include a control question. The control question may be communicated to the patient. The control question has a correct response that is known to the first medical professional before the question is communicated. The control question is a closed-ended question where the potential responses are limited to a finite number of predetermined choices capable of being provided to the first medical professional without a translator. After receiving a response from the patient, the first medical professional may compare the response to the correct response and thus, determine the truthfulness of the patient's responses. In addition to determining truthfulness, the control question may enable the medical professional to determine whether the patient understands the question being given. By way of example, the control question may be asking a female about a male health problem or vice versa. Accordingly, the appropriate response would be that the question does not apply to the patient.

A plurality of translating medical professionals may each provide reference information 340. Reference information 340 may be stored within electronic database 310. Reference information 340 may include the medical professional's professional expertise, identity, and any languages and dialects that the medical professional is fluent in. The medical professional may translate at least one of the closed-ended questions 330 into their fluent language or dialect. Translations 350 are recorded and used to establish electronic database 310. Additional medical professionals may provide additional translations 350 in their respective fluent languages or dialects.

FIG. 2 shows a method 200 for establishing translations 350 in database 310. First, a medical professional's verification rating is determined in step 210. Next, the medical professional may record translation 351a of question 331 in step 220. In step 230, medical professionals may review translations 350 of other medical professionals speaking a similar language or dialect. Upon review, the medical professionals may provide accuracy ratings of the recorded translations 350 in step 240. Each accuracy rating may consist of a value, such as a rating out of 100. The accuracy rating may simply be an approval (value of 100) or rejection (value of 0) of the translation. In step 250, trust rating 361 of a particular recorded translation 351a is calculated based upon the number and value of the accuracy ratings given by the reviewing medical professionals. A particular recorded translation 351a may be excluded from electronic database 310 until trust rating 361 of the particular recorded translation 351a has reached a predetermined level.

Decision step 260 determines whether trust rating 361 for translation 351a is above the predetermined level. For example, a minimum of three approval accuracy ratings may be used to establish the requisite trust rating 361 before translation 351a may be added into electronic database 310 in step 270. If trust rating 361 is above a predetermined level, the particular translation 351a is made available to users in electronic database 310. If trust rating 361 is below a predetermined level, additional medical professionals will continue to review and provide accuracy ratings for translation 351a. If translation 351a has been reviewed a sufficient number of times to determine that trust rating 361 did not achieve the predetermined level, translation 351a may be discarded.

The first medical professional may have the option to select a translation of a second question 332 from database 310. Rather than requiring a set flow of questions, the second question 332 may be selected by the first medical professional based upon the response to the first question 331. For example, the first medical professional may select follow-up questions. The translation of the second question 332 may likewise be communicated to the patient and a response may be elicited. A second translation of the second question 332 may be offered to the patient. This may reduce errors and misunderstandings in the translation process. As may be appreciated by one of the ordinary skill in the art having the benefit of this disclosure, the first medical professional may select as many questions and as many corresponding translations as are necessary to accurately complete the admissions process.

Medical professionals wishing to provide translations 350 of questions 330 may have their credentials verified. The translating medical professionals may also have their identities verified. Even so, the translating medical professionals may provide translations anonymously once their credentials and identities are verified.

As discussed above, verification ratings 370 of the translating medical professionals may be determined. Verification rating 371 of a particular medical professional demonstrates the trustworthiness of the translating medical professional. For example, verification rating 371 of a particular medical professional may be at least partially determined by the identity and professional expertise of the translating medical professional.

A system for facilitating medical admissions includes an electronic database, a first translation of a first question, a trust rating, and a plurality of designed response cues. The electronic database includes translations of closed-ended questions. The translations have the property of being prerecorded by medical professionals as audio or video translations, or both. The first translation of the first question is among the prerecorded translations contained within the electronic database. The first translation is specific to a particular language. The potential responses to the first question are limited to finite number of predetermined choice.

The trust rating is associated with the first translation of the first question. The trust rating has the property of being established by a plurality of medical professionals in response to reviewing the first translation of the first question. The plurality of designated response cues provide a plurality of answers to the closed-ended questions. The plurality of answers correspond to the potential responses and the answers are configured to be communicated to a medical professional without a translator.

As an example of the above described system, FIG. 3 shows a block diagram of system 300 for facilitating medical admissions between a first medical professional a patient with a communication barrier. System 300 may be restricted to the admissions process in medical environments or environments where privacy or confidentiality is a paramount concern. However, it is foreseeable that system 300 may be used beyond the admissions process, such as to assist a nurse in assessing a patient's pain levels or symptoms. Examples of medical environments include hospitals, clinics, refugee camps, improvised care center, and in-field trauma sites. System 300 may be used not only in medical settings in more developed nations, but also in less developed nations, in cases of regions suffering social/political unrest, in regions where there are unclear borders, and in refugee camps (and/or migratory populations). The communication barrier may be that the patient prefers to give medical information in their native language or may not speak a common language with the medical professional. For example, an immigrant or refugee may not speak a local language or dialect. Also, a traveling medical professional may travel to regions where she does not speak the local language.

System 300 includes electronic database 310 and response cues 320. Electronic database 310 may include closed-ended questions 330, translations 350, trust ratings 360, and verification ratings 370. Electronic database 310 includes translations 350 of closed-ended questions 330 that are prerecorded by medical professionals. Each translation 351a,b of each question 331 is specific to a particular language or dialect. The potential responses to questions 330 are limited to a finite number of choices. Trust ratings 360 are associated with translations 350 of questions 330. Trust rating 361 for translation 351a of a particular question 331 may be provided by medical professionals who have reviewed translation 351a to determine its accuracy. System 300 may include reference information 340. Reference information 340 may include verification ratings 370 of medical professionals.

Response cues 320 provide a plurality of answers to closed-ended questions 330 and correspond to the finite number of choices of the potential responses. Some questions 330 may include a visual diagram to assist the patient in answering the question. For example, a diagram of the human body may be included to assist in identifying a source of pain. The answers to questions 330 may be communicated to a medical professional without the use of a translator. By way of example, the finite number of choices for the potential responses may be “yes,” “no,” “I don't know,” “I don't understand the question,” or “I prefer not to answer the question.” The use of the same choices for every question 330 within electronic database 310 may aid the speed of the admissions process and reduce confusion for the patient. Some of translations 350 may be video translations of questions 330 in hearing-impaired languages.

Translations 350 may be procured remotely on an as-needed basis. However, as internet access is not readily available in parts of the world, the system 300 may be configured to operate without the need for internet access. FIG. 4 shows a block diagram of an electronic device 400 with local memory 410 configured to store at least of portion of electronic database 310. Electronic device 400 may be a portable device having local memory 410. At least a portion of electronic database 310 may be stored in a database 415 on local memory 410 of the portable device. For example, local memory 410 may store database 415 comprising closed-ended questions 330, translations 350, trust ratings 360, and verification ratings 370.

Electronic device 400 may include user interface 440 that provides access to electronic database 310. Using user interface 440 a medical professional may access questions 330 and translations 350. By way of example, user interface 440 may be a touch screen of a tablet computer. Electronic device 400 may include an audio device, such as speaker 430, that communicates an audio translation to the patient. Electronic device 400 may include a video device, such as LED display 420, that communicates a video translation to the patient.

System 300 may include supplemental closed-ended questions 335 (shown in FIG. 3) that differ from closed-ended questions 330 in electronic database 310. Supplemental questions 335 may be directed to medical conditions unique to a local geographic region and may be provided by a medical professional within the local geographic region. Allowing medical professionals the option of providing supplemental questions 335 may increase the system's ability to react to an event, such as a sudden global health epidemic or the spread of communicable diseases. Trust rating 360 necessary for translations of supplemental questions 335 may be reduced in order to more readily address sudden events. Translations of supplemental questions 335 may be provided by medical professionals into their respective fluent languages and dialects. Once approved, supplemental questions 335 may become part of closed-ended questions 330.

Closed-ended questions 330, supplemental questions 335, and translations 350 may be initially withheld from general access within database 310. Closed-ended questions 330 and supplemental questions 335 may be provided to medical professionals in written form, who in turn translate them in their fluent language or dialect. For example, a medical professional fluent in Arabic may provide an audio translation 351a of question 331 in Arabic. Also for example, a medical professional fluent in American Sign Language may provide a video recording of the question in American Sign Language. Each question would not be open-ended, but would have a plurality of responses from which to choose. The translating medical professional's reference information 341 may be included in database 310.

Subsequently, translations 350 may be reviewed by other medical professionals. The reviewing medical professionals may be medical professionals who provided other translations. The reviewing medical professionals may listen or view recorded translations 350 that are in a language or dialect in which the reviewing medical professional is fluent. The reviewing medical professionals verify the accuracy of a particular translation 351a and assign an accuracy rating to translation 351a. The aggregate of these accuracy ratings may be used to determine trust rating 361 of the particular translation 351a. Once trust rating 361 of translation 351a exceeds a predetermined level, question 331 is made available to medical professionals wishing to provide translation services to patients. Translations 350 may be made available through electronic database 310 provided to the medical professionals.

By way of example, a list of closed-ended questions 330 in varying languages may be proliferated as follows. A medical professional may be provided with a closed-ended question 331 in written form to translate into his native language. The medical professional may write question 331 in their native language before providing a translation. For example, a medical professional with a native language of French may read a question in English, draft a text translation of the question in French, and provide an audio translation in French. Another medical professional with a native language of Hindi may read the question in French, draft a text translation of the question in Hindi, and provide an audio translation in Hindi. The text translations might not be made available to patients. Instead, the text translations may be used by medical professionals to determine which questions 330 should be used when admitting a patient.

A system for facilitating medical admissions between a first medical professional and a patient includes reference information, a plurality of predetermined closed-ended questions, a plurality of recorded audio or video translations, or both, and a database. The reference information corresponds to a plurality of medical professionals and includes a respective medical professional's professional expertise and fluent language. Each of the plurality of recorded translations is provided by one of the plurality of medical professional in the respective medical professional's fluent language and has a corresponding trust rating based upon a plurality of accuracy ratings given by two or more of the plurality of medical professionals not providing the reviewed translation. The database contains the plurality of predetermined closed-ended questions and the plurality of translations having a trust rating above a predetermined level.

System 300 may include reference information 340, predetermined closed-ended questions 330, recorded translations 350, and electronic database 310. Reference information 340 may be a plurality of reference information 341 corresponding to a plurality of medical professionals. For example, reference information 340 for a particular medical professional may include a respective medical professional's identity, professional expertise, and languages and dialects in which the medical professional is fluent. Translations 350 are translations of predetermined closed-ended questions 330. Each translation 351a is provided by a medical professional in that medical professional's fluent language. Translations 350 may be restricted to a medical professional's native language or dialect. Each of the translations 351a includes trust rating 361 that is determined from accuracy ratings given by reviewing medical professionals that did not provide the translation. Electronic database 310 contains closed-ended questions 330 and translations 350 that have a trust rating above a predetermined level.

Some of translations 350 may be video translations of questions in a hearing-impaired language. A portion of electronic database 310 may be stored on local memory 410 of a portable device. Predetermined closed-ended questions 330 may include questions regarding basic hospital and emergency room intake, questions of an epidemiological nature, questions of a social nature, admissions questions, psychological questions, and triage questions. For example, basic hospital and emergency room intake questions may include “Are you allergic to Latex?” Epidemiological questions may include “Have you had contact with anyone with active tuberculosis disease in the past year?” Triage questions may include “Is your breathing normal?” Psychological questions may include ““Have you had hallucinations?” or “Have you heard voices?” In some embodiments, patients wishing to receive help of a social nature (for example the exploitation of minors or in cases of human trafficking) would have a way of expressing this to the medical professional, and being referred to appropriate care groups after receiving a future medical consultation for it.

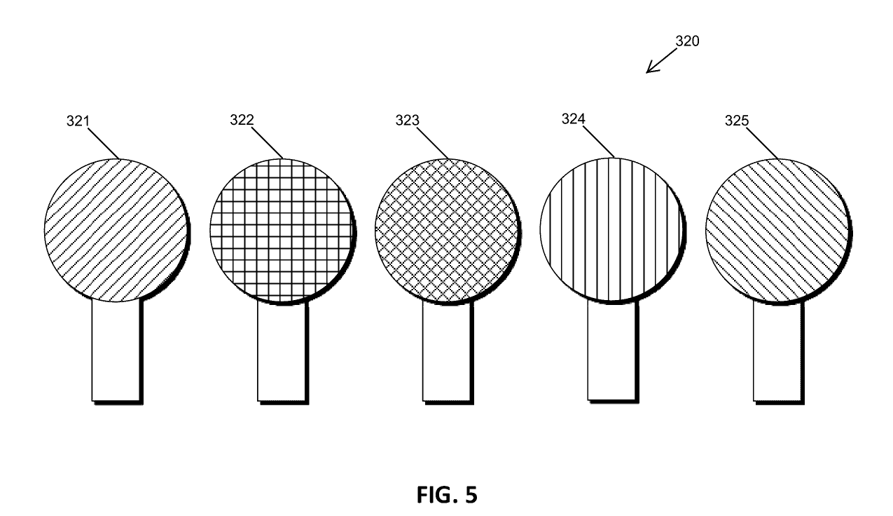

FIG. 5 shows responses cues 320 as a set of response devices 321, 322, 323, 324, and 325. Each response device 321, 322, 323, 324, and 325 corresponds to a potential response to question 331. As shown, the response devices may be color-coded paddles or strips and the color of the strip may correspond to a potential response. Therefore, the response devices may be used to communicate the potential responses with a medical professional. By way of example, response device 321 may correspond to the potential response “yes,” response device 322 may correspond to the potential response “no,” response device 323 may correspond to the potential response “I don't know,” response device 324 may correspond to the potential response “I don't understand the question,” and response device 325 may correspond to the potential response “I prefer not to answer the question.” The response cues may be hand gestures. For example, a patient may hold up a single finger for “yes” and five fingers for “no.”

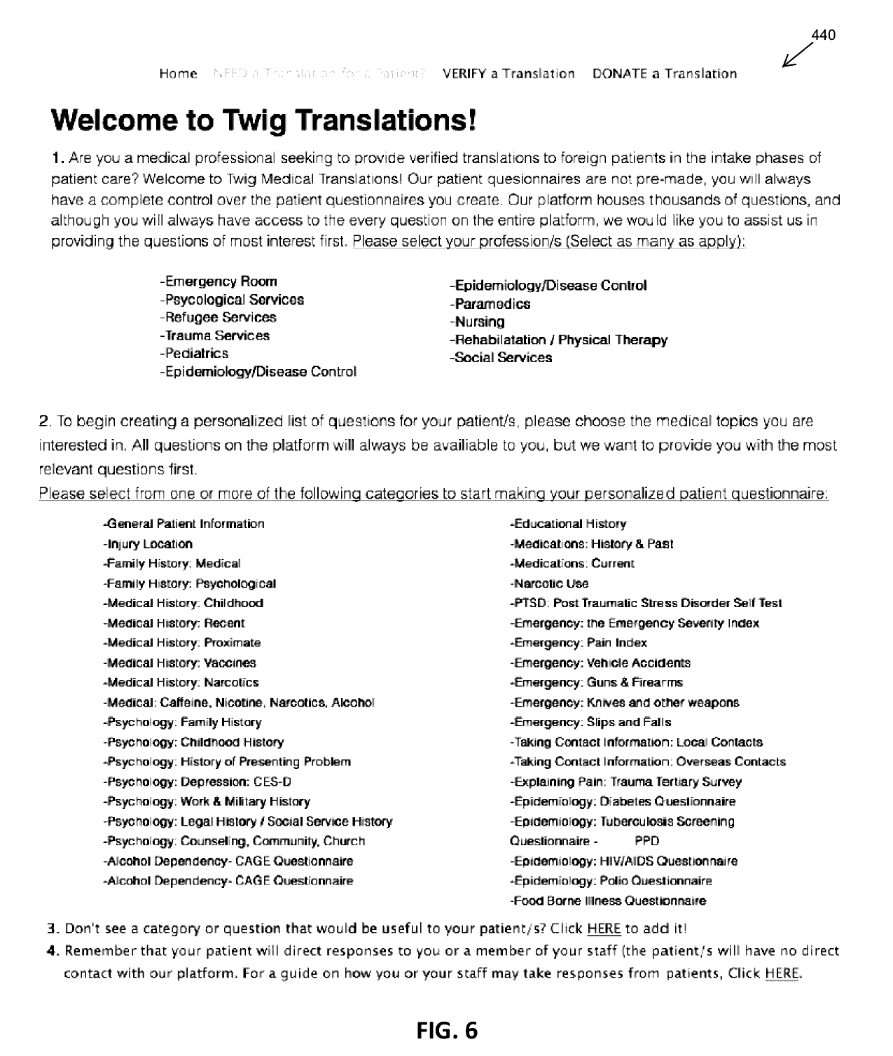

FIG. 6 shows an example of user interface 440 on electronic device 400 for a first medical professional to access database 310. The first medical professional may be prompted to select their profession to assist in focusing closed-ended questions 330 and corresponding translations 350 to the medical professional's focus area. Questions 330 may be divided into categories to assist the first medical professional in finding relevant questions. The first medical professional may create a personalized patient questionnaire by selecting questions from electronic database 310.

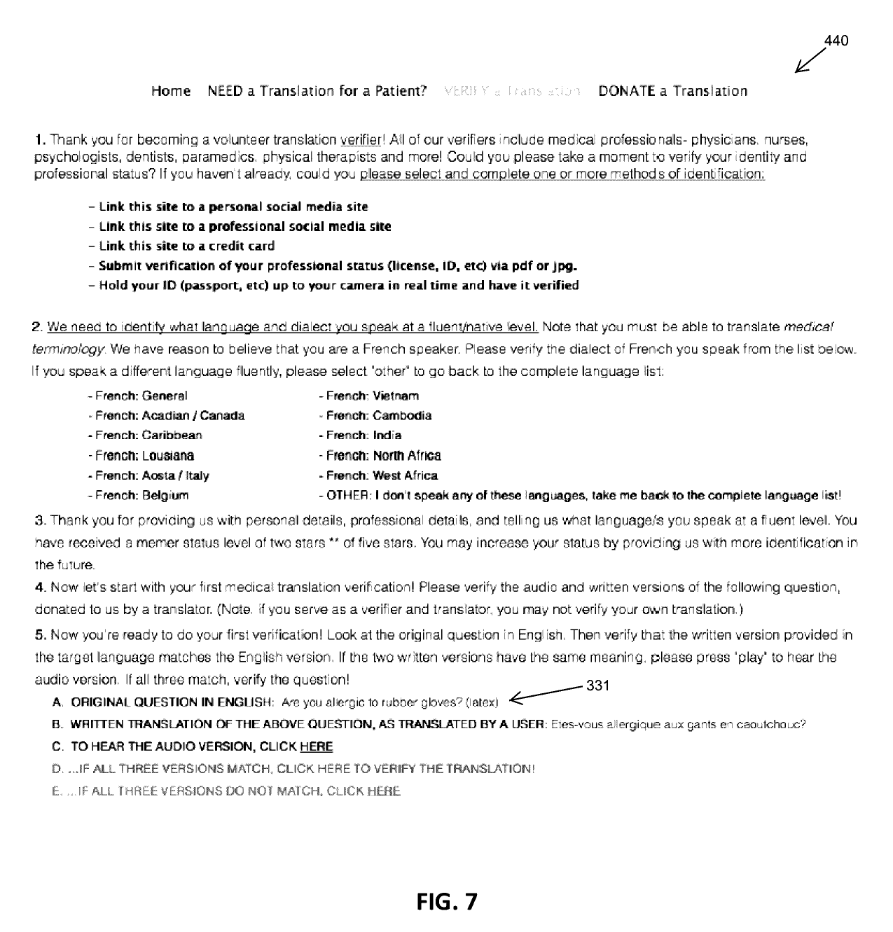

FIG. 7 shows an example of user interface 440 on electronic device 400 for reviewing medical professionals to verify the accuracy of translations 350. A reviewing medical professional may be prompted to provide their identity and professional expertise. The reviewing medical professionals will be prompted to identify languages and dialects that they are a fluent or native speaker of. The reviewing medical professional compares a written translation of question 331 in the target language to a copy of the question in the original language. If the two written translations match, the reviewing medical professional may then review the recorded translation 351a corresponding to question 331. The medical professional may then approve or reject the recorded translation 351a based upon its accuracy. In some embodiments, a numerical value is used to represent the accuracy of translation 351a.

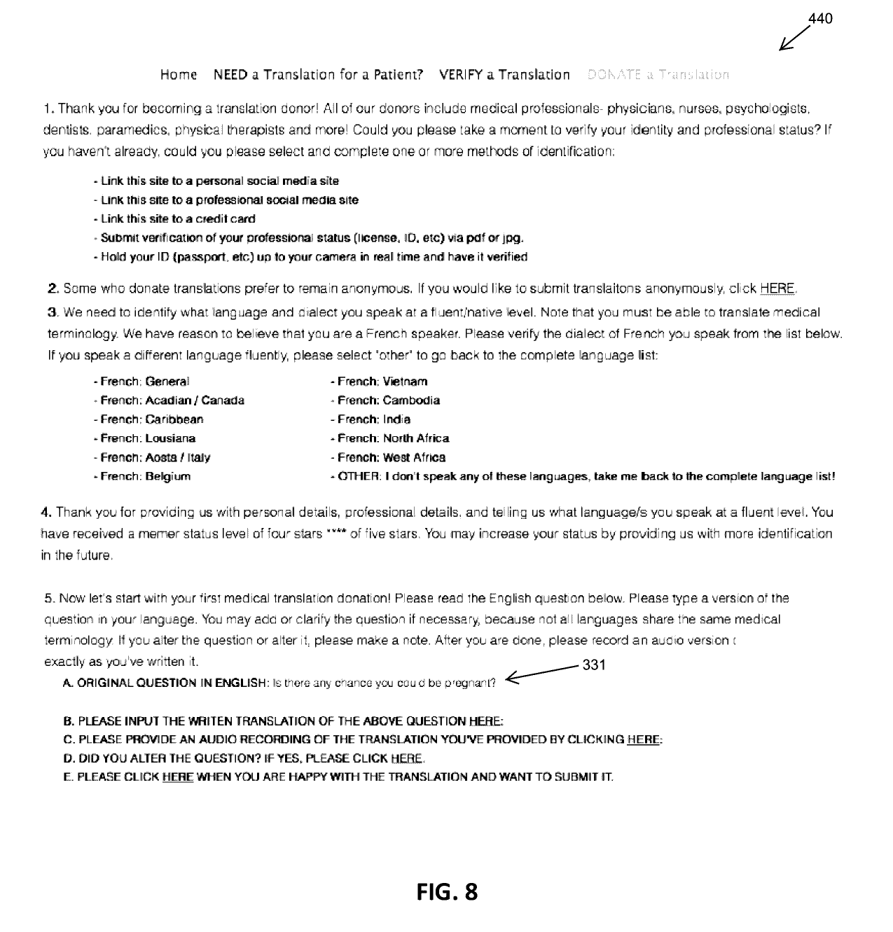

FIG. 8 shows an example of user interface 440 on electronic device 400 for providing translations 350 of closed-ended questions 330. A translating medical professional may be prompted to provide their identity and professional expertise. The translating medical professional will be prompted to identify languages and dialects that she is a fluent or native speaker of. The translating medical professional's verification rating 371 may be at least partially determined by the identity and professional expertise entered by the translating medical professional. The translating medical professional is provided with a written question 331 in an understood language. The translating medical professional may provide both a written and an audio translation 351a of question 331 in the target language.

In compliance with the statute, the embodiments have been described in language more or less specific as to structural and methodical features. It is to be understood, however, that the embodiments are not limited to the specific features shown and described. The embodiments are, therefore, claimed in any of their forms or modifications within the proper scope of the appended claims appropriately interpreted.

What is claimed is:

1. A method for facilitating medical admissions, the method comprising:
a first medical professional ascertaining an understood language of a patient, a communication barrier existing between the first medical professional and the patient;
the first medical professional accessing an electronic database on an electronic device configured to communicate with the patient, the electronic database comprising a plurality of closed-ended questions in the first medical professional's understood language and corresponding prerecorded translations provided by other medical professionals, the prerecorded translations being audio or video translations, or both;
the first medical professional selecting a first translation of a first question from among the prerecorded translations in the electronic database through the electronic device, the first translation corresponding to the understood language of the patient;
communicating the first translation of the first question to the patient through the electronic device; and
eliciting a response to the first question from the patient, the potential responses being limited to a finite number of predetermined choices known to the first medical professional, the response being provided to the first medical professional without a translator.

2. The method of claim 1, wherein at least a portion of the prerecorded translations have an associated trust rating having the property of being established by a plurality of medical professionals.

3. The method of claim 1, wherein the response to the first question is a nonverbal response.

4. The method of claim 1, wherein the predetermined closed-ended questions include intake questions, triage questions, and epidemiology questions.

5. The method of claim 4, wherein the electronic device is a portable device having a local memory and, further comprising storing the electronic database onto the local memory of the portable device, the first medical professional accessing the first translation of the first question from the local memory of the portable device.

6. The method of claim 1, wherein the potential responses to the plurality of closed-ended questions are limited to the same predetermined choices known to the medical professional.

7. The method of claim 6, wherein one of the potential responses is declining to answer the question.

8. The method of claim 1, wherein the first translation of the first question is a video translation in a hearing-impaired language.

9. The method of claim 3, further comprising communicating a second translation of the first question to the patient, the second translation being different from the first translation, and the response being to the first translation and the second translation of the first question.

10. The method of claim 9, further comprising:
communicating a translation of a control question having a correct response to the patient, the first medical professional knowing the correct response to the control question before the control question is communicated;
eliciting a response to the control question from the patient, the potential responses being limited to a finite number of predetermined choices, the response being provided to the first medical professional without a translator; and
the first medical professional comparing the response to the control question to the correct response to determine the truthfulness of the response to the control question.

11. The method of claim 1, further comprising:
each of a plurality of medical professionals providing respective reference information, the respective reference information including the medical professional's professional expertise and fluent language;
each of the plurality of medical professionals translating at least one predetermined closed-ended question in the respective medical professional's fluent language;
recording the translations; and
establishing an electronic database comprised of the recorded translations.

12. The method of claim 11, further comprising:
two or more medical professionals reviewing at least one of the recorded translations of another medical professional, the two or more reviewing medical professional providing accuracy ratings of the at least one of the recorded translations;
determining a trust rating of a particular recorded translation based upon the number and value of the accuracy ratings given by the two or more reviewing medical professionals; and
adding the particular recorded translation to the electronic database when the trust rating of the particular recorded translation reaches a predetermined level.

13. The method of claim 12, further comprising determining a verification rating of a particular medical professional providing translations.

14. A system for facilitating medical admissions between a first medical professional and a patient having a communication barrier, the system comprising:
an electronic database including translations of closed-ended questions, the translations being prerecorded by medical professionals as audio or video translations, or both;
a first translation of a first question among the prerecorded translations contained within the electronic database, the first translation being specific to a particular language, the potential responses to the first question being limited to a finite number of predetermined choices;
a trust rating associated with the first translation of the first question, the trust rating having the property of being established by a plurality of medical professionals in response to reviewing the first translation of the first question; and
a plurality of designated response cues that provide a plurality of answers to the closed-ended questions, the plurality of answers corresponding to the potential responses, the answers being configured to be communicated to a medical professional without a translator.

15. The system of claim 14, wherein the first translation is a video translation of the first question in a hearing-impaired language.

16. The system of claim 14, wherein the response cues are a set of response devices, each response device corresponding to a potential response to the first question.

17. The system of claim 14, wherein the response cues are hand gestures.

18. The system of claim 14, further comprising a portable device having local memory, the local memory storing the electronic database.

19. The system of claim 14, further comprising a user interface providing access to the electronic database, the user interface enabling the first medical professional to select a translation of a question.

20. The system of claim 19, further comprising an audio device configured to communicate an audio translation to the patient.

21. The system of claim 20, further comprising a video device configured to communicate a video translation to the patient.

22. A system for facilitating medical admissions between a first medical professional and a patient having a communication barrier, the system comprising:
reference information corresponding to a plurality of medical professionals, the reference information including a respective medical professional's professional expertise and fluent language;
a plurality of predetermined closed-ended questions;
a plurality of recorded audio or video translations, or both, of at least one of the predetermined closed-ended questions, each recorded translation being provided by one of the plurality of medical professional in the respective medical professional's fluent language, each of the plurality of recorded translations having a corresponding trust rating based upon a plurality of accuracy ratings given by two or more of the plurality of medical professionals not providing the reviewed translation; and
a database containing the plurality of predetermined closed-ended questions and the plurality of translations having a trust rating above a predetermined level.

23. The system of claim 22, wherein at least one translation is a video translation of a question in a hearing-impaired language.

24. The system of claim 23, further comprising a portable device having a local memory storing a portion of the database.

25. The system of claim 22, wherein the predetermined closed-ended questions include intake questions, triage questions, and epidemiology questions.

26. The system of claim 25, further comprising:
at least one supplemental closed-ended question differing from the closed-ended questions in the database, the at least one supplemental closed-ended question being directed to medical conditions unique to a local geographic region, the at least one supplemental closed-ended question being provided by a medical professional within the local geographic region; and
a plurality of recorded translations of at least one supplemental closed-ended question, each recorded translation being provided by one of the plurality of medical professional in the respective medical professional's fluent language.

27. The system of claim 22, wherein the reference information includes a verification rating of a respective medical professional.
